(19) United States
(12) Patent Application Publication
(10) Pub. No.: US 2010/0325625 A1
(43) Pub. Date: Dec. 23, 2010

(54) MANAGING ELECTRONIC DEVICES WITH DIFFERENT TYPES OF DEVICE LOCATION LIMITED DEVICE MANAGEMENT CLIENTS

(76) Inventors: Osvaldo Diaz, San Mateo, CA (US); Mamoun Abu-Samaha, San Jose, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/866,781

(22) PCT Filed: Oct. 31, 2008
(86) PCT No.: PCT/US08/81949

§ 371 Date: Aug. 9, 2010

Related U.S. Application Data
(60) Provisional application No. 61/028,313, filed on Feb. 13, 2008.
(60) Provisional application No. 61/028,319, filed on Feb. 13, 2008.

(51) Int. Cl. G06F 9/445

(52) U.S. Cl. 717/176

(57) ABSTRACT

Various embodiments pertain to managing electronic devices with different types of device location limited device management clients. According to one embodiment, first information describing first device capabilities 122 for a first type of device location limited device management client 126 associated with a first electronic device 120 is received. Second information describing second device capabilities 132 for a second type of device location limited device management client 136 associated with a second electronic device 130 is received. A device location agnostic device management client 124 is installed on the first electronic device 120 while communicating with the first electronic device 120 based on the first device capabilities 122. The device location agnostic device management client 134 is installed on the second electronic device 130 while communicating with the second electronic device 130 based on the second device capabilities 132.

### RELATED APPLICATIONS

This patent application claims priority to and benefit of the co-pending U.S. Provisional Patent Application No. 61/028,319 which has an Attorney Docket Number 200801140-1, and is entitled “Remote Management with Translation Between OMA-DM and WSMAN” by Osvaldo Diaz et al., filed on Feb. 13, 2008.

This patent application claims priority to and benefit of the co-pending U.S. Provisional Patent Application No. 61/028,313 which has an Attorney Docket Number 200801143-1, and is entitled “Hosted Management Server Supporting Multiple Management Frameworks” by Osvaldo Diaz et al., filed on Feb. 13, 2008.

This application is related to U.S. patent application Ser. No. ______ by Osvaldo Diaz et al., filed on the same date as the present application and entitled “Providing Manageability to an Electronic Device That Supports Location Limited Manageability Functionality” with attorney docket no. 200801140-2, assigned to the assignee of the present application.

### BACKGROUND

A management platform defines a standard that software, referred to herein as an “entity,” can be developed around, according to one embodiment. One entity is typically a managing entity that manages another entity (also referred to as “a managed entity”) and by extension manages the device that a managed entity resides on. Entities that conform to related management platforms can communicate with each other with a corresponding management protocol. Although entities are frequently describes as software, entities that conform to management platforms may also be implemented using hardware or firmware, or a combination of any two or more of software, hardware, or firmware.

Examples of management platforms that have corresponding management protocols are Open Mobile Alliance Device Management (OMA-DM), Web Services Management (WSMAN), Simple Network Management Protocol (SNMP), Technical Requirement-069 (TR-069), and TR-111. The entities typically use a communication protocol, such as TCP-IP, to transmit information that conforms to the respective management protocol to enable a managing entity to manage a managed entity.

Management platforms and their respective management protocols can be either location agnostic or location limited. Location limited device management pertains to managing devices but restricts where those devices are located. For example, the devices may be restricted to a network associated with an enterprise or a home. WSMAN, SNMP, TR-069 and TR-111 are examples of location limited platforms. Location agnostic device management pertains to managing devices regardless of where the devices are located. A location agnostic protocol is a management protocol that can be used for communicating between entities that reside on devices regardless of where the devices are located. OMA-DM is an example of a location agnostic platform.

There are many different types of electronic devices, such as routers, gateways, cell phones, televisions, set-top-boxes, computers, printers, etc. These various electronic devices use many different types of communication protocols to exchange information between devices. In addition, there are management protocols or management platforms that are used to provide management services, such as configuration, security, diagnosis, etc. to devices having a common communication protocol. For example, a set-top-box may use the TR-111 management protocol when connected via a LAN through an Internet gateway and a laptop may use the Web Services Management (WSMAN) protocol to exchange information with other devices. As time goes on, more types of electronic devices will be available utilizing more types of protocols and management platforms.

### BRIEF DESCRIPTION OF THE DRAWINGS

The accompanying drawings, which are incorporated in and form a part of this specification, illustrate embodiments of the invention and, together with the description, serve to explain the principles of embodiments of the invention:

FIG. 1 is a block diagram of a system for managing electronic devices with different types of location limited clients, according to one embodiment.

FIG. 2 depicts a flowchart describing,a method of managing electronic devices with different types of device location limited device management clients, according to one embodiment.

FIG. 3 is a block diagram of a system for translating functions between a location agnostic entity and a location limited entity, according to one embodiment.

FIG. 4 is a block diagram of a system for translating functions between a location agnostic entity and a location limited entity, according to another embodiment.

FIG. 5 depicts a block diagram of one example of a type of computer that can be used in accordance with or to implement various embodiments which are discussed herein.

The drawings referred to in this description are not drawn to scale except if specifically noted.

### DESCRIPTION

Reference will now be made in detail to various embodiments of the invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following description of various embodiments of the present invention, numerous specific details are set forth in order to provide a thorough understanding of the present invention. In other instances, well-known methods, procedures, components, and circuits have not been described in detail so as not to unnecessarily obscure aspects of the present invention.

Since there are many different types of electronic devices with many different types of communications protocols and management platforms as well as electronic devices that lack management platforms, there is a need for a method and a system to communicate and manage these disparate electronic devices, for example, with one management model. Further, there is a need for managing these disparate electronic devices from a single user interface.

According to one embodiment, an apparatus associated with a multi-management capable server receives the device capabilities of various electronic devices. The apparatus uses the device capabilities to determine which management platform, with a corresponding management client and management protocol, each of the electronic devices use. The determined management protocols are used to install device management client (also referred to herein as “location agnostic client” or as “a device location agnostic device management client”) which is agnostic as to the location of a device, such as OMA-DM, onto the electronic devices. For example, if electronic device A's device capabilities indicates that electronic device A complies with the WSMAN platform, then the WSMAN protocol is used to install a location agnostic client, such as an OMA-DM client, onto electronic device A. If another electronic device B's device capabilities indicate that electronic device B complies with the TR-069 platform, then the TR-069 protocol is used to install an OMA DM client onto electronic device B. The location agnostic clients that are installed on the electronic devices A and B can be used to communicate with a device location agnostic management server (also referred to herein as a “location agnostic server” or “management server”) to provide management to both of the electronic devices A and B.

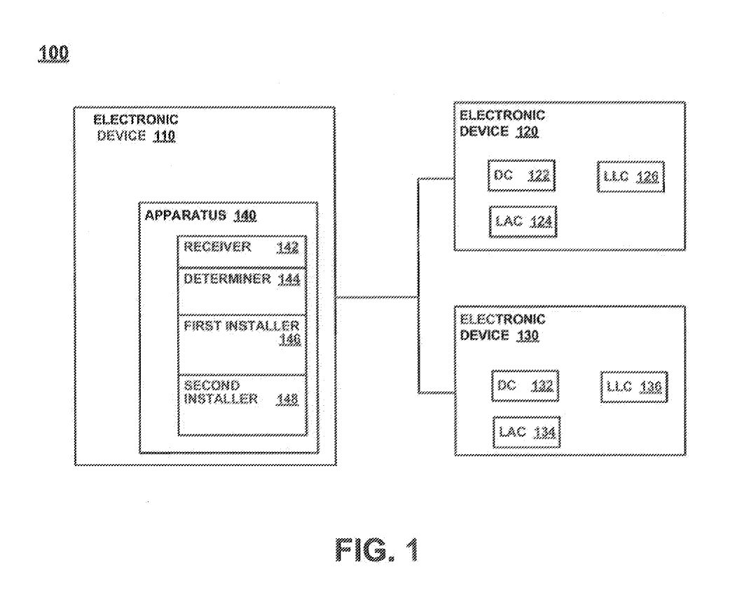

FIG. 1 is a block diagram of a system for managing electronic devices with different types of location limited clients, according to one embodiment. The blocks that represent features in FIG. 1 can be arranged differently than as illustrated, and can implement additional or fewer features than what are described herein. Further, the features represented by the blocks in FIG. 1 can be combined in various ways. The system 100 can be implemented using software, hardware, firmware, or a combination thereof.

FIG. 1 depicts two electronic devices 120, 130 where different types of location limited clients (“LLC”) 126 and 136 are associated with each of the electronic devices 120, 130. For example, location limited client 126 is associated with electronic device 120 and location limited client 136 is associated with electronic device 130.

Each of the electronic devices 120, 130 have respective device capabilities (“DC”) 122, 132. The device capabilities 122, 132 can be used to determine what type of location limited client 126, 136 is associated with the respective electronic devices 120, 130, as will become more evident.

An apparatus 140 is associated with electronic device 110. According to one embodiment, the apparatus 140 is an apparatus for managing electronic devices 120, 130 with different types of location limited clients 126, 136. The apparatus 140 includes a multi-device-management-device-capabilities-receiver 142 (also referred to herein as “a receiver”), a multi-device-management-protocol-determiner 144 (also referred to herein as “a determiner”), a first-multi-device-management-location-agnostic-device-management-client-based-on-determined-protocol-installer 146 (also referred to herein as “a first installer”), and a second-multi-device-management-location-agnostic-device-management-client-based-on-determined-protocol-installer 148 (also referred to herein as “a second installer”).

The receiver 142 is configured for receiving information describing device capabilities 122, 132 of electronic devices 120, 130. The determiner 144 is configured for determining management protocols for electronic devices 120, 130 based on the device capabilities 122, 132 associated with the electronic devices 120, 130. The first installer 146 is configured for installing a device location agnostic device management client 124 on a first electronic device 120 while communicating with the first electronic device 120 using a first management protocol. The second installer 148 is configured for installing the device location agnostic device management client 134 on a second electronic device 130 while communicating with the second electronic device 130 using a second management protocol.

According to one embodiment, the installers 146, 148 are configured with a minimal set of commands associated with a management protocol that would be used for installing a location agnostic client (“LAC”) 124, 134. For example, assume that electronic device 120's location limited client 126 is a TR069 client and that electronic device 130's location limited client 136 is a WSMAN client. The first installer 146 associated with the apparatus 140 may include software instructions that result in TR-069 protocol commands for installing a location agnostic client 124, such as an OMA-DM client, onto electronic device 120 and the second installer 148 may include software instructions that result in WSMAN protocol commands for installing a location agnostic client 134, such as an OMA-DM client, onto the other electronic device 130.

The electronic device 110 that the apparatus 140 resides on, according to one embodiment, may be a computer based server. The electronic device 110 may be a web server that provides a web server application. The electronic device 110 may be a computer based server associated with a company that sells electronic devices 120, 130 or associated with a traditional IT enterprise. These are just a few examples of the types of electronic devices 110 that the apparatus 140 may be associated with.

As will become more evident, according to one embodiment, one or more management servers manage the respective electronic devices 120, 130, for example by diagnosing, configuring, supporting, etc. The one or more management servers may be located on the electronic device 110 or may be located separately. The one or more management servers may be location limited servers or location agnostic servers or a combination thereof.

An electronic device 110, 120, 130 may be a mobile device such as a cell phone, a laptop, or a personal digital assistant (PDA), among other things. An electronic device 110, 120, 130 may be a device that is used in a home, such as a router, a gateway, a modem, a kitchen appliance, a television, a set-top-box, a computer, a printer, and a laptop, among other things. An electronic device 110, 120, 130 may be a device that is used for work (also referred to herein as “work devices”), such as routers, a modem, a gateway, a computer, a laptop, a phone, a PDA, and a printer, among other things. Work devices may be used by a company or an enterprise that traditionally provides information technology. A company may be a small, medium or large-sized company. An electronic device 110, 120, 130 may be a computer based device, such as a desk top computer, a laptop, or a server device, among other things. An electronic device 110, 120, 130 may be a client device or a server device.

An electronic device 120, 130 may be managed by a traditional information technology (IT) enterprise, such as Hewlett Packard™, according to one embodiment. An electronic device 120, 130 may be sold by a company, such as Best Buy™, that is not a traditional IT enterprise.

Home devices may be behind a network address translation (NAT) table or a firewall, or a combination thereof, among other things. Work devices may be behind a firewall, among other things. Using an electronic device 120, 130's device capabilities 122, 132 to install a location agnostic client 124, 136 with an electronic device 120, 130 enables a management server, which may be located at an electronic device 110 or located separately from the electronic device 110, to manage a location agnostic client 124, 136 even when the electronic device 120, 130 is behind a firewall or a Network Translation Address (NAT) table or enables a management server to manage an electronic device 120, 130 that has never been a part of a traditional IT enterprise.

Different electronic devices 120, 130 have different capabilities 122, 132. Information describing an electronic device 120, 130's capabilities 122, 132 can be used to determine the management protocol that an electronic device 120, 130 is configured to use. For example, information describing a device 120, 130's capabilities can be used to determine that the electronic device 120, 130 has the ability to communicate using WSMAN or TR-069, for example.

The device capabilities 122, 132 may be requested or provided without being requested. For example, when an electronic device 120, 130 is turned on it performs a process called “boot strapping” during which the electronic device 120, 130 is provisioned. While boot strapping, the electronic device 120, 130 may communicate with a management server, that may be associated with electronic device 110, that can either request the electronic device 120, 130's capabilities 122, 132 or the electronic device 120, 130 may provide its capabilities without the management server requesting the capabilities.

According to one embodiment, registration information for an electronic device 120, 130 can be used by the determiner 144 to determine the management protocol that the electronic device 120, 130 is configured to use. The registration information may be provided by a company that sells electronic devices to, for example, a company that is a traditional IT enterprise that an apparatus 140 is associated with. The registration information may be provided to any entity, such as a management server, that an apparatus 140 communicates with for managing electronic devices with different types of location limited clients, according to various embodiments.

According to one embodiment, information describing device capabilities 122, 132 can be determined based on management policies that reside for example with a management server, a service provider, the electronic device 120, 130 in question, or at another electronic device associated with the same environment, such as a home or business premises, that the electronic device 120, 130 in question is associated with.

According to one embodiment, information describing device capabilities 122, 132 can be used for reinstalling a management client 124, 126, 134, 136, such as a location limited client 126, 136 or a location agnostic client 124, 134, for example, if a management client 124, 126, 134, 136 is corrupted or disappears.

Managing electronic devices 120, 130 include any one or more of managing, supporting, securing, and diagnosing electronic devices 120, 130. Examples of managing electronic devices 120, 130 include but are not limited to updating an application, diagnosing a software or hardware error, limiting the type of content that can be viewed, providing manageability to devices 120, 130 that are behind a NAT, a gateway, or a firewall, providing manageability to devices 120, 130 sold by companies that are not traditional IT enterprises, providing manageability to devices 120, 130 with different carriers, providing manageability to devices 120, 130 associated with small or medium-sized businesses that do not have traditional IT infrastructures, and so on, as will become more evident.

Location limited device management pertains to managing devices 120, 130 but restricts where those devices 120, 130 are located. That is, location limited device management can only be used to manage devices 120, 130 while the devices 120, 130 are in a particular physical or electronic (network) location. For example, the devices 120, 130 may be restricted to a network associated with an enterprise or a home. A location limited protocol is a management protocol (also referred to herein as a “device management protocol”) that can be used for communicating between a managing entity, such as a managing server, managed entities, such as managed clients 126, 136, that reside on electronic devices 120, 130 while those devices 120, 130 are associated with a particular area or a particular network. Examples of location limited protocols are Web Services Management (WSMAN), Simple Network Management Protocol (SNMP), TR-069, and TR-111.

Many electronic devices are traditionally configured to communicate using location limited protocols. For example, many computer based devices are configured to use the WSMAN protocol. In another example, many chip sets are configured to use the WSMAN protocol. In yet another example, many televisions are configured to use TR-111. In still another example, many routers and modems are configured to use TR-069.

A location limited entity may be a client, such as location limited clients 126, 136, or a server, among other things, that conforms to a location limited management platform, such as WSMAN, SNMP, TR-069, or TR-111. A location limited entity may reside on an electronic device 110, 120, 130.

Location agnostic device management pertains to managing devices 120, 130 regardless of where the devices 120, 130 are located. A location agnostic protocol is a management protocol (also referred to as a “device management protocol”) that can be used for communicating between a managing entity, such as a management server, and a managed entity, such as a managed client 124, 136, that reside on devices 120, 130 regardless of where the devices 120, 130 are located. The location agnostic protocol, according to one embodiment, is an HyperText Transfer Protocol (HTTP) Extensible Markup Language (XML) based protocol that can be used, for example, by phones. The location agnostic protocol may enable part of the communications to be transmitted over the Internet. Short message service (SMS), for example, may be used to initiate communications. A location agnostic protocol can be used, for example, to communicate via one or more cell phone towers and the Internet. An example of a location agnostic protocol is the OMA-DM protocol.

Since a location agnostic protocol can be used to communicate via one or more cell phone towers and the Internet, a location agnostic protocol can be used to communicate with electronic devices 120, 130 regardless of where they are located. For example, a location agnostic protocol can be used to communicate with an electronic device 120, 130 even when that electronic device 120, 130 moves. In another example, a location agnostic protocol can be used to communicate with an electronic device 120, 130 that is behind a NAT, or behind a firewall.

A user interface, such as a self-care web-site or a user interface associated with an information technology enterprise can be used as a part of providing management to various electronic devices 120, 130. For example, the electronic device 110 may be associated with a self-care web site or an IT user interface. Further, by installing location agnostic clients 124, 134 on various electronic devices 120, 130, a single user interface can be used for managing the various types of electronic devices 120, 130.

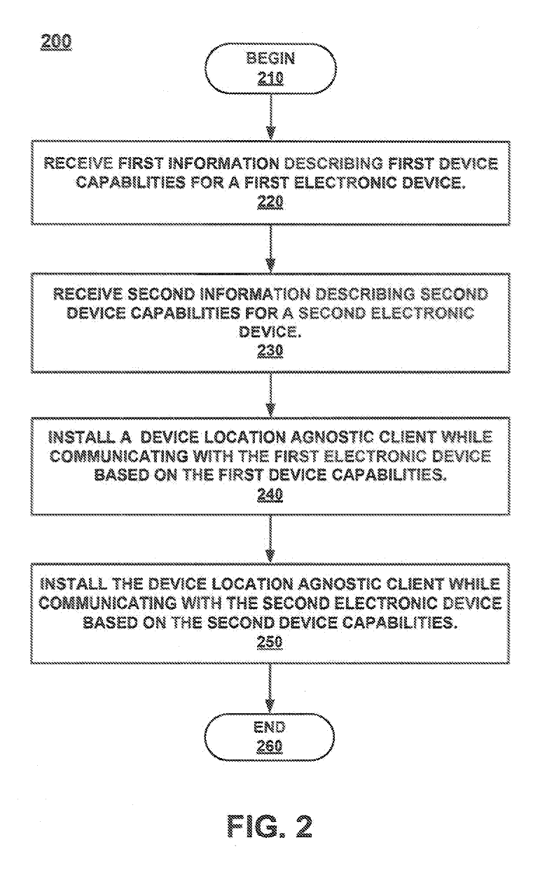

FIG. 2 depicts a flowchart 200 for a method of managing electronic devices with different types of device location limited device management clients, according to one embodiment. Although specific steps are disclosed in flowchart 200, such steps are exemplary. That is, embodiments of the present invention are well suited to performing various other steps or variations of the steps recited in flowchart 200. It is appreciated that the steps in flowchart 200 may be performed in an order different than presented, and that not all of the steps in flowchart 200 may be performed.

Assume that an OMA-DM server resides on electronic device 110, which has an apparatus 140. Assume that the first installer 146 associated with the apparatus 140 is capable of installing a location agnostic client 124, such as an OMA-DM client, using TR-069 install commands onto an electronic device 120 and the second installer 148 associated with apparatus 140 is capable of installing a location agnostic client 134, such as an OMA-DM client, using WSMAN install commands onto another electronic device 130.

Assume that electronic device 120 has a TR-069 client 126, which is one type of location limited client, and electronic device 130 has a WSMAN client 136, which is another type of location limited client.

At 210, the method begins.

At 220, first information describing first device capabilities for a first electronic device is received. For example, the receiver 142 associated with electronic device 110 receives first information describing the device capabilities 122 of electronic device 120. The OMA-DM server associated with the electronic device 110 may request information describing the device capabilities 122. The receiver 142 may request the first information or the first information may be provided to the receiver 142 without requesting the first information.

The determiner 144 associated with the OMA-DM server on electronic device 110 determines the appropriate installer 146 or 148 based on the received first information describing the device capabilities 122. For example, determiner 144 uses the first information received by receiver 142 to determine that the appropriate installer for electronic device 120 is the TR-069 installer 146.

At 230, second information describing second device capabilities for a second electronic device is received. Similar processing as described at 220 is performed with respect to second information describing second device capabilities 132, which indicates that the location limited client 136 associated with the second electronic device 130 is a WSMAN client.

At 240, a device location agnostic client is installed while communicating with the first electronic device based on the first device capabilities. For example, the TR-069 installer 146 installs a location agnostic client 124, such as an OMA-DM client, onto electronic device 120. The TR-069 installer 146 may be implemented to use a minimal set of commands associated with the TR-069 protocol. For example, the minimal set of commands may only include the TR-069 commands that are used for installing software. The location agnostic client 124 is not installed if the location agnostic client 124 is already installed on the electronic device 120.

At 250, the device location agnostic client is installed while communicating with the second electronic device based on the second device capabilities. For example, similar processing as described at 240 is performed with respect to the WSMAN installer 148 using a minimal set of commands associated with the WSMAN protocol to install a location agnostic client 134, which in this illustration is an OMA-DM client. The location agnostic client 134 is not installed if the location agnostic client 134 is already installed on the electronic device 130.

At 260, the method ends.

The installed location agnostic clients 124 and 134 can be used as a part of communicating with the respective electronic devices 120, 130 and also as a part of managing the respective electronic devices 120, 130 regardless of where the electronic devices 120, 130 are located. For example, assume that electronic device 120 is lost and the user of electronic device 120 calls up customer service or goes to a self care portal associated with the OMA-DM server, for example, and requests that the hard disk on electronic device 120 be reformatted or that electronic device 120 be locked up. The OMA-DM server can communicate with the installed OMA-DM client 124 on electronic device 120 to reformat electronic device 120's hard disk or to lock electronic device 120. Customer care may use an OMA-DM user interface as a part of reforming electronic device 120's hard disk or locking electronic device 120.

Assume in another example that electronic device 120 encounters a software or hardware error that does not render the electronic device 120 inoperable. The OMA-DM client 124 on electronic device 120 can communicate information pertaining to the error to an OMA-DM server. Information Technology (IT) specialists can look at the diagnostic information received by the OMA-DM server to help the user of electronic device 120 to determine the problem. Further, the OMA-DM server can communicate software updates or configuration changes to electronic device 120's OMA-DM client 124 to provide fixes based on the diagnosis of the problem.

By installing location agnostic clients on various electronic devices 120, 130, one type of management server can be used for managing electronic devices 120, 130 regardless of the type of location limited clients 126, 136 that were originally associated with the electronic devices 120, 130 and regardless of where the electronic devices 120, 130 are located. Further, a single user interface can be used for managing the various types of electronic devices 120, 130. For example, the electronic device 110 may be associated with a self-care web site or a user interface for an information technology enterprise. Service providers that have contracted with the IT enterprise do not need to know which management framework a specific electronic device 120, 130 supports. Instead, the service providers can employ management screens, or web pages, or a combination associated with, for example, a location agnostic server regardless of what location limited protocol the electronic device 120, 130 originally supported.

Management can be provided to electronic devices by configuring the electronic devices and diagnosing problems associated with the electronic devices, among other things. An electronic device that uses a location limited client (“location limited” shall be used herein to refer to “device location limited management”) lose its management capabilities when the electronic device moves outside of an area that the electronic device is configured to use. A network that the electronic device is configured to use is an example of an area where the electronic device is provided manageability via the electronic device's location limited client communicating with a location limited server over the network.

Various embodiments pertain to providing manageability to an electronic device, which supports location limited manageability functionality, even when the electronic device moves outside of the area. For example, a location agnostic entity (“location agnostic” shall be used herein to refer to “device location agnostic device management”), which is capable of providing management regardless of where an electronic device is located, can be installed on the electronic device. The location agnostic entity and the location limited entity associated with the electronic device both provide a variety of functions. Function A provided by the location agnostic entity may provide similar management capabilities as function A′ associated with the location limited entity associated with the electronic device. Therefore, according to one embodiment, a mapping between a location agnostic entity's functions and the location limited entity's functions is used as a part of providing manageability even when the electronic device moves outside of an area, as will become more evident.

Conventionally, electronic devices that are behind a network address translation table (NAT) cannot communicate with an entity that provides management, which is on the other side of the network address translation table (NAT). However, various embodiments enable electronic devices behind a NAT to be managed by communicating with the managing entity that is on the other side of a NAT. In another example, a conventional electronic device may be managed only while it is associated with a certain network. The electronic device may or may not be behind a firewall. However, various embodiments enable electronic devices to be managed when the electronic device leaves the network. Various embodiments can also be used for electronic devices that have never been a part of a traditional IT network, such as a cell phone. Various embodiments can be used for devices that cross between a traditional IT enterprise environment and non-traditional IT enterprise environment. Various embodiments can be used for devices for small or medium-sized businesses (SMBs) that do not have traditional IT support capabilities. Therefore, various embodiments are well suited to home devices, which may be behind a NAT or a firewall, or a combination thereof, or a work device, which may be behind a firewall, among other things.

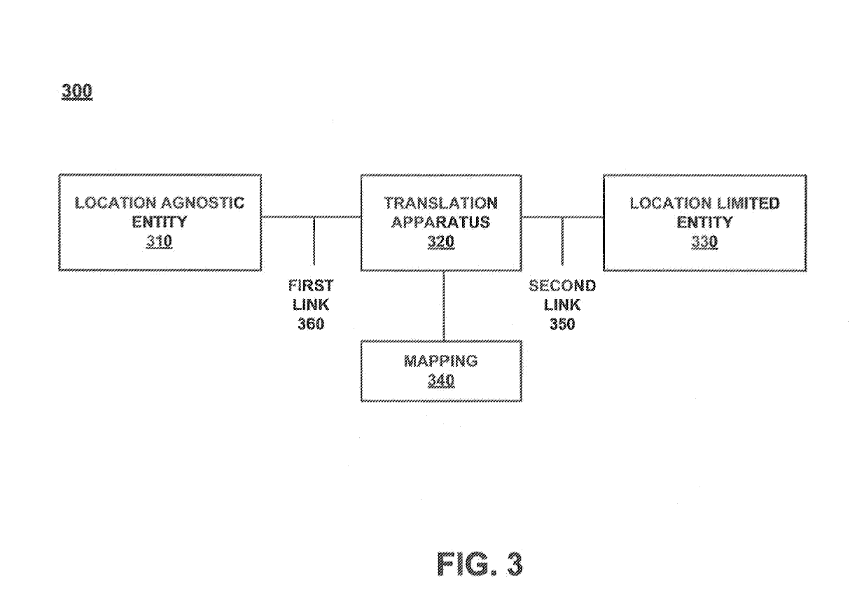

FIG. 3 is a block diagram of a system 300 for translating functions between a location agnostic device management entity (also known as “location agnostic entity”) and a location limited device management entity (also known as “location limited entity”), according to one embodiment. The blocks that represent features in FIG. 3 can be arranged differently than as illustrated, and can implement additional or fewer features than what are described herein. Further, the features represented by the blocks in FIG. 3 can be combined in various ways. The system 300 can be implemented using software, hardware, firmware, or a combination thereof.

The system 300 includes a location agnostic entity 310, a location limited entity 330, a mapping 340 between functions associated with the two entities 310 and 330, and a translation apparatus 320 for translating functions between the two entities 310 and 330.

The entities 310, 330 may be either clients or servers. Either the first link 360 or the second link 350, or both of the links 360, 350 may be a communications link over a network or may be a communications link that resides in an electronic device. The first link 360, or the second link 350 or both of the links 360, 350 may have WiFi capabilities.

The apparatus 320 can be co-located with the location agnostic entity 310. For example, the apparatus 320 and the location agnostic entity 310 may reside on the same server or on a network operations center (NOC), among other things. The location agnostic entity 310 and the apparatus 320 may both be associated with a data center for an IT enterprise or reside with a web server.

The apparatus 320 may be co-located with the location limited entity 330. For example, the apparatus 320 and the location limited entity 330 may reside on an electronic client device.

The apparatus 320, the location agnostic entity 310, and the location limited entity 330 may all reside on the same electronic device, may be associated with the same company, or may be associated the same traditional IT enterprise. The electronic device may be a client device or a server device. The server device may be a web server.

The apparatus 320 may be located separately from both the location agnostic entity 310 and the location limited entity 330. For example, the apparatus 320 may be located on an electronic device, such as a server device, that is separate from the electronic devices that the location agnostic entity 310 and the location limited entity 330 reside on. In one embodiment, the location agnostic entity 310, or the apparatus 320, or a combination thereof, reside on a web server. The mapping 340 may be co-located with the translation apparatus 320 or may be located separately from the translation apparatus 320.

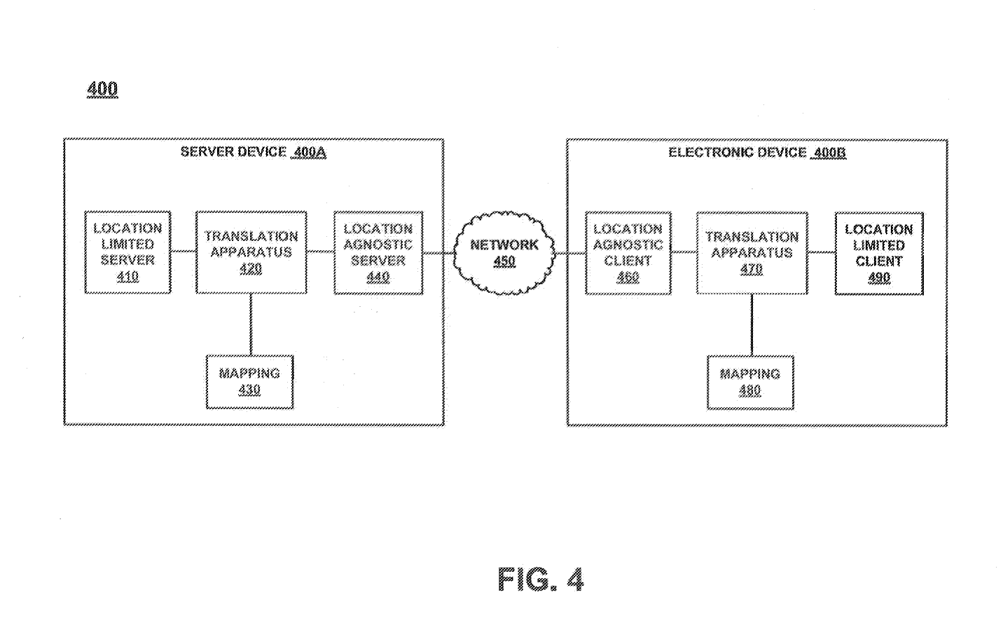

FIG. 4 is a block diagram of a system 400 for translating functions between a location agnostic entity and a location limited entity, according to another embodiment. The blocks that represent features in FIG. 4 can be arranged differently than as illustrated, and can implement additional or fewer features than what are described herein. Further, the features represented by the blocks in FIG. 4 can be combined in various ways. The system 400 can be implemented using software, hardware, firmware, or a combination thereof.

As depicted in FIG. 4, the translation can occur between two servers 410, 440 and between two clients 460, 490. For example, the first translation apparatus 420 and its corresponding mapping 430 can translate functions between a location limited server 410 and a location agnostic server 440. The second translation apparatus 470 and its corresponding mapping 480 can translate functions between a location agnostic client 460 and a location limited client 490.

The location limited server 410 and the location limited client 490 are examples of location limited entities 330. The location agnostic server 440 and the location agnostic client 460 are examples of location agnostic entities 310.

Although the server device 400A, as depicted in FIG. 4, includes the servers 410, 440, the translation apparatus 420, and the mapping 430, the server device 400A may include only one or may include more than one of the servers 410, 440, the first translation apparatus 420, or the first mapping 430. The server device 400A may be associated with a service provider. Any one or more of the servers 410, 440, the first translation apparatus 420, or the first mapping 430 can reside at, among other things, a network operations center, an enterprise, or a server device 400A. The server device 400A may be a web server.

Although the client device 400B, as depicted in FIG. 4, includes the clients 460, 490, the translation apparatus 470 and the mapping 480, the client device 400B may include only one or may include more than one of the clients 460, 490, the second translation apparatus 470, and the second mapping 480. The electronic device 400B may be, among other things, a mobile device, an appliance, a router, a model, a television, or a computer.

Communications between various entities depicted in FIG. 4 may be performed over an Internet. For example, the network 450 may be the Internet. Communications between the location agnostic server 440 and the location agnostic client 460 depicted in FIG. 4 may be performed over a network 450 that includes Wireless Fidelity (WiFi) capabilities. Although network 450 is the only network depicted in FIG. 4, according to various embodiments, a network may be used to communicate between any of the components 410, 420, 430, 440, 460, 470, 480, 490 depicted in FIG. 4.

According to one embodiment, electronic devices 120, 130 (FIG. 1) with different types of location limited clients 126, 136 can be managed in the context of either a system 300 or system 400. For example, an electronic device 120, 130 (FIG. 1) may include any one or more of a location agnostic entity 310, translation apparatus 320, mapping 340, and location limited entity 330. According to one embodiment, a management server, which may be located on the electronic device 110 (FIG. 1) or may be located separately, may include any one or more of a location agnostic entity 310, translation apparatus 320, mapping 340, and location limited entity 330. According to one embodiment, an electronic device 120, 130 may be an electronic device 400B and the management server may reside on a server device 400A. Translation apparatuses 470 and corresponding mappings 480 can also be used to bridge communications between the respective location agnostic clients 125 and 134 and location limited clients 126 and 136 associated with the electronic devices 120, 130.

Various embodiments described herein can also be used to install a translation apparatus 470 and a corresponding mapping 480 in addition to installing the location agnostic client 126, 136 on an electronic device 120, 130, as will become more evident.

Management can be provided to electronic devices by configuring the electronic devices and diagnosing problems associated with the electronic devices, among other things. For example, an electronic device can be managed by updating an application or diagnosing an error. In a second example, several electronic devices 400B, such as a television, a personal computer for work, and a laptop may all be connected to a router in a home. The router would use a NAT to provide connectivity for the three devices. The NAT would translate a single real IP address into three pseudo IP addresses for the three devices. Traditionally this has made it very difficult to manage devices 400B that are behind a NAT. Further, many of these devices 400B would have location limited functionality. However, according to various embodiments, a location agnostic protocol can be used to provide manageability to these devices 400B even though they are behind a NAT by communicating with cell phone towers and the Internet.

In another example, a person that works for company X may take their laptop 400B that is configured for company X's network, that is behind a firewall X′, to another company Y that has a network behind firewall Y′. Traditionally, one or more firewalls, such as firewall X′ and Y′, would prevent the person from using their laptop 400B while inside of company Y. However, according to various embodiments, a location agnostic protocol and one or more translation apparatuses 320, 420, 470 and corresponding mappings 340, 430, 480 can enable the laptop 400B to communicate around the firewalls.

In yet another example, a person buys a laptop, a handset phone, or a mobile device from a company that sells electronic devices 400B. Assume that this company is not a traditional IT enterprise but is interested in providing manageability to the devices 400B that they sell. According to various embodiments, the electronic devices 400B they sell may have clients 460 and 490 and a second translation apparatus 470 as depicted in FIG. 4. The company may have servers 410 and 440 and a first translation apparatus 420 as depicted in. FIG. 4 to provide the manageability to the electronic devices 400B that the company sells.

In still another example, assume that the electronic device 400B is lost and the user of the electronic device 400B calls up customer services or goes to a self care portal associated with a location agnostic server 440, such as an OMA-DM server, and requests that the hard disk on the electronic device 400B be reformatted or that the electronic device 4008 be locked up. The location agnostic server 440 can communicate with the location agnostic client 460 on the electronic device 400B to reform that electronic device 400B's hard disk or to lock the electronic device 400B. Customer care may interact with a user interface associated with the location agnostic server 440 as a part of reformatting the electronic device 400B's hard disk or locking the electronic device 400B.

Other examples where various embodiments may be used include, but are not limited to, different phones with different protocols, different carriers, small or medium businesses that do not have traditional IT infrastructure, changing chip sets in a computer 400B where the original chip set and the new chip set use different protocols for providing manageability, a lost electronic device 400B, locking an electronic device 400B, reformatting hard disk on an electronic device 400B, shredding a hard disk on an electronic device 400B, recovering data, determining what OS was running on a device 400B, which has a crashed disk configuration.

Various embodiments provide a mapping 340, 430, 480 between a device location agnostic entity 310, 440, 460's functions and a device location limited entity 330, 410, 490's functions. According to one embodiment, the device location agnostic entity 310, 440, 460's functions are represented by OMA-DM objects (also known as “managed objects”). For example, a mapping 480 associated with an electronic client device 400B may map managed objects (MOs) to device location limited functions, such as WSMAN functions.

The mapping 340, 430, 480 may map a subset of the functions associated with a device location limited entity 330, 410, 490 and a device location agnostic entity 310, 440, 460. The determination may be made by analyzing what functions are used most often or what functions would provide the greatest business opportunity.

In one embodiment, a translation apparatus 320 and a corresponding mapping 340 may be implemented as a proxy client, which resides, for example, on a Network Operations Center (NOC) server. For example, assume that the location agnostic entity 310, such as an Open Mobile Alliance Device Management (OMA-DM) server, is associated with a service provider's server device, the translation apparatus 320 and corresponding mapping 340 are associated with a proxy client on the NOC server, and the location limited entity 330, such as a WSMAN client, is associated with a user's electronic device. Also assume that the user's electronic device includes a minimal location agnostic client, such as a minimal OMA-DM client. The NOC server with the associated proxy client and the location agnostic entity 310 may be associated with the same data center. The NOC server with the associated proxy client and the WSMAN location limited entity 330 may be associated with the same data center.

A help desk or a user self care web page may communicate with the location agnostic entity 310 which in turn communicates with the proxy client. The proxy client can use the translation apparatus 320 and the mapping 340 to determine a location agnostic function. A data structure representing the determined function can be communicated, using the OMA DM protocol, to the user's electronic device. The electronic device can use the minimal OMA-DM client to extract the data structure and communicate the pertinent information to the location limited entity 330.

As stated in the above example, the electronic client can use a minimal location agnostic client, such as minimal OMA-DM client. For example, if a location agnostic management platform and corresponding protocol provide interfaces for functions A, B and C but function A will suffice, the minimal location agnostic client may support function A but not support functions B and C.

According to one embodiment, the OMA DM protocol is used to communicate, for example, over the second link 350 as depicted in FIG. 3 or to communicate, for example, over the network 450 as depicted in FIG. 4. According to one embodiment, the OMA DM protocol is modified so that electronic devices that include a location limited entity 330 or a location limited client 490, among other things, are always connected and therefore Short Message Services (SMSs) are not required.

According to one embodiment, what is commonly known as “push technology” is used as a part of various client or server entities communicating. For example, “push technology” may be used to communicate between a translation apparatus 320 and a location agnostic entity 310 or between a translation apparatus 320 and a location limited entity 330. In another example, “push technology” may be used to provide communications between a location agnostic server 440 and a location agnostic client 460 or vice versa.

“HTTP server push” is one subcategory of “push technology” According to one embodiment, HTTP server push is used as a part of communicating, for example, between a server 400A and a client 400B. HTTP server push typically involves a server 400A pushing information to a client 400B. In situations where a client 400B is pushing information to a server 400A, the client 400B may employ a push technology that is similar to HTTP server push.

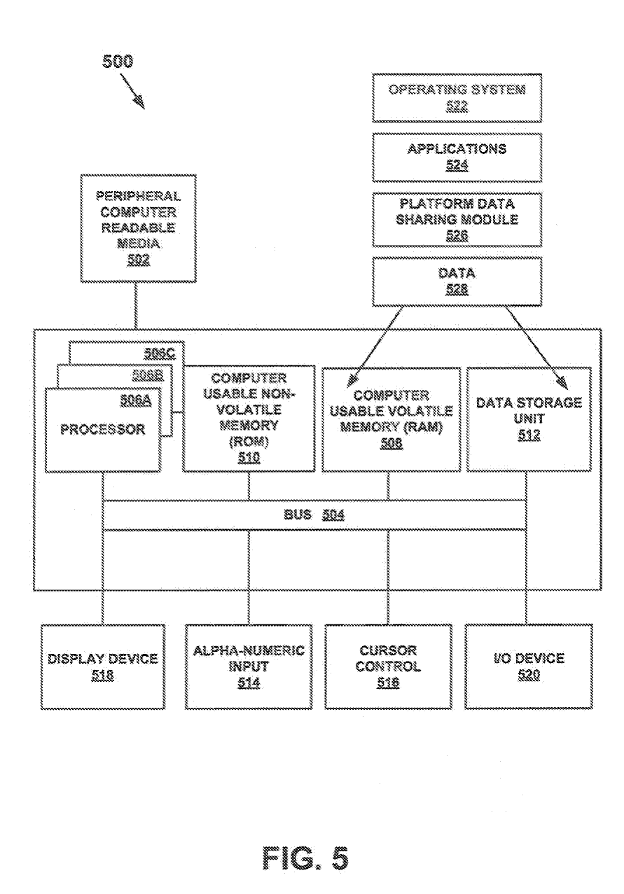

FIG. 5 depicts a block diagram of one example of a type of computer (computer system 500) that can be used in accordance with or to implement various embodiments which are discussed herein. It is appreciated that computer system 500 of FIG. 5 is only an example and,that embodiments as described herein can operate on or within a number of different computer systems including, but not limited to, general purpose networked computer systems, embedded computer systems, routers, switches, server devices, client devices, various intermediate devices/nodes, stand alone computer systems, media centers, handheld computer systems, multi-media devices, and the like. As shown in FIG. 5, computer system 500 of FIG. 5 is well adapted to having peripheral computer-readable media. 502 such as, for example, a floppy disk, a compact disc, and the like coupled thereto.

System 500 of FIG. 5 includes an address/data bus 504 for communicating information, and a processor 506A coupled to bus 504 for processing information and instructions. As depicted in FIG. 5, system 500 is also well suited to a multi-processor environment in which a plurality of processors 506A, 506B, and 506C are present. Conversely, system 500 is also well suited to having a single processor such as, for example, processor 506A. Processors 506A, 506B, and 506C may be any of various types of microprocessors. System 500 also includes data storage features such as a computer usable volatile memory 508, e.g. random access memory (RAM), coupled to bus 504 for storing information and instructions for processors 506A, 506B, and 506C. System 500 also includes computer usable non-volatile memory 510, e.g. read only memory (ROM), coupled to bus 504 for storing static information and instructions for processors 506A, 506B, and 506C. Also present in system 500 is a data storage unit 512 (e.g., a magnetic or optical disk and disk drive) coupled to bus 504 for storing information and instructions. System 500 also includes an optional alphanumeric input device 514 including alphanumeric and function keys coupled to bus 504 for communicating information and command selections to processor 506A or processors 506A, 506B, and 506C. System 500 also includes an optional cursor control device 516 coupled to bus 504 for communicating user input information and command selections to processor 506A or processors 506A, 506B, and 506C. In one embodiment, system 500 also includes an optional display device 518 coupled to bus 504 for displaying information.

Referring still to FIG. 5, optional display device 518 of FIG. 5 may be a liquid crystal device, cathode ray tube, plasma display device or other display device suitable for creating graphic images and alphanumeric characters recognizable to a user. Optional cursor control device 516 allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch pad, joystick or special keys on alpha-numeric input device 514 capable of signaling movement of a given direction or manner of displacement. Alternatively, it will be appreciated that a cursor can be directed and/or activated via input from alpha-numeric input device 514 using special keys and key sequence commands. System 500 is also well suited to having a cursor directed by other means such as, for example, voice commands. System 500 also includes an I/O device 520 for coupling system 500 with external entities. For example, in one embodiment, I/O device 520 is a modem for enabling wired or wireless communications between system 500 and an external network such as, but not limited to, the Internet.

Referring still to FIG. 5, various other components are depicted for system 500. Specifically, when present, an operating system 522, applications 524, modules 526, and data 528 are shown as typically residing in one or some combination of computer usable volatile memory 508, (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable media within data storage unit 512, peripheral computer-readable media 502, and/or other tangible computer readable media.

For example, the apparatus 140 (FIG. 1), the instructions for implementing the flowchart 200 (FIG. 2), the DCs 122, 132, the LACs 124, 134, the LLCs 126, 136 (FIG. 1), the translation apparatuses 320, 420, 470, and the corresponding mappings 340, 430, 480 (FIGS. 3 and 4) may be associated with a computer 500. The, apparatus 140 (FIG. 1), the instructions for implementing the flowchart 200 (FIG. 2), the DCs 122, 132, the LACs 124, 134, the LLCs 126, 136 (FIG. 1), the translation apparatuses 320, 420, 470, and the corresponding mappings 340, 430, 480 (FIGS. 3 and 4) may be associated with the computer 500 in the form of hardware, software, firmware, or a combination thereof. In the case of software, instructions implementing the apparatus 140 (FIG. 1), the flowchart 200 (FIG. 2), the LACs 124, 134, the LLCs 126, 136 (FIG. 1), the translation apparatuses 320, 420, 470, and the corresponding mappings 340, 430, 480 (FIGS. 3 and 4) may be associated with the applications 524 or the peripheral computer-readable media 502, among other things. The mappings 340, 430, 480 (FIGS. 3 and 4) and the DCs 122, 132 may be stored as data 528, among other things.

Various embodiments have been described in various combinations. However, any two or more embodiments may be combined. Further, any embodiment may be used separately from any other embodiments.

The foregoing description, for purposes of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of managing electronic devices with different types of device location limited device management clients, the method comprising:
receiving 220 first information describing first device capabilities 122 for a first type of device location limited device management client 124 associated with a first electronic device 120;
receiving 230 second information describing second device capabilities 132 for a second type of device location limited device management client 134 associated with a second electronic device 130;
installing 240 a device location agnostic device management client 124 on the first electronic device 120 while communicating with the first electronic device 120 based on the first device capabilities 122; and
installing 250 the device location agnostic device management client 134 on the second electronic device 130 while communicating with the second electronic device 130 based on the second device capabilities 132.

2. The method as recited by claim 1, wherein the method further comprises:
determining the management protocol used by the first device 120 based on the first information describing the first device capabilities 122; and
installing the device location agnostic device management client 124 on the first electronic device 120 while communicating with the first electronic device 120 using the determined management protocol.

3. The method as recited by claim 1, wherein the method further comprises:
receiving the first information as apart of requesting the first information.

4. The method as recited by claim 1, wherein the method further comprises:
receiving the first information without requesting the first information.

5. An apparatus for managing electronic devices with different types of device location limited device management clients, the apparatus comprising:
a multi-device-management-device-capabilities-receiver 142 configured for receiving 220, 230 information describing device capabilities 122, 132 of electronic devices 120, 130;
a multi-device-management-protocol-determiner 144 configured for determining device location limited management protocols for electronic devices 120, 130 based on the device capabilities 122, 132 associated with the electronic devices 120, 130;
a first-multi-device-management-location-agnostic-device-management-client-based-on-determined-protocol-installer 146 configured for installing 240 a device location agnostic device management client 124 on a first electronic device 120 while communicating with the first electronic device 120 using a first determined management protocol; and
a second-multi-device-management-location-agnostic-device-management-client-based-on-determined-protocol-installer 148 configured for installing 250 the device location agnostic device management client 134 on a second electronic device 130 while communicating with the second electronic device 130 using a second determined management protocol.

6. The apparatus of claim 5, wherein the device location limited protocols are selected from a group consisting of Web Services Management (WSMAN), Simple Network Management Protocol (SNMP), Technical Requirement-069 (TR-069), and Technical Requirement-111 (TR-111).

7. The apparatus of claim 5, wherein the device location agnostic device management client 124, 134 is an Open Mobile Alliance Device Management (OMA-DM) client.

8. The apparatus of claim 5, wherein the apparatus 140 is associated with a management server that uses a translation apparatus 144 that translates functions between a device location agnostic device management server 148 and a device location limited device management server 142.

9. The apparatus of claim 5, wherein the apparatus 140 is associated with a management server that communicates with a managed client that includes a translation apparatus 270 that translates functions between a device location agnostic device management client 126 and a device location limited device management client 124.

10. A computer-usable medium having computer-readable program code stored thereon for causing a computer system to perform a method of managing electronic devices with different types of device location limited device management clients, the method comprising:
receiving 220 first information describing first device capabilities 122 for a first type of device location limited device management client 126 associated with a first electronic device 120;
receiving 230 second information describing second device capabilities 132 for a second type of device location limited device management client 1136 associated with a second electronic device 130;
installing 240 a device location agnostic device management client 124 on the first electronic device 120 while communicating with the first electronic device 120 based on the first device capabilities 122; and
installing 250 the device location agnostic device management client 134 on the second electronic device 130 while communicating with the second electronic device 130 based on the second device capabilities 132.

11. The computer readable medium of claim 10, wherein the computer-readable program code embodied therein causes a computer system to perform the method, and wherein the method further comprises:
determining the management protocol used by the first device 120 based on the first information describing the first device capabilities 122; and
installing the device location agnostic device management client 124 on the first electronic device 120 while communicating with the first electronic device 120 using the determined management protocol.

12. The computer readable medium of claim 10, wherein the computer-readable program code embodied therein causes a computer system to perform the method, and wherein the method further comprises:
using a translation apparatus 270 to translate functions between the device location limited device management client 126 associated with the first device 120 and the installed device location agnostic device management client 124 associated with the first device 120.

13. The computer readable medium of claim 10, wherein the computer-readable program code embodied therein causes a computer system to perform the method, and wherein the method further comprises:
managing the first and second electronic devices 120, 130 with the device location agnostic device management clients 124, 134 installed on the first and second electronic devices 120, 130.

14. The computer readable medium of claim 10, wherein the computer-readable program code embodied therein causes a computer system to perform the method, and wherein the types of device location limited device management clients 126, 136 are selected from a group consisting of Web Services Management (WSMAN), Simple Network Management Protocol (SNMP), Technical Requirement-069 (TR-069), and Technical Requirement-111 (TR-111).

15. The computer readable medium of claim 10, wherein the computer-readable program code embodied therein causes a computer system to perform the method, and wherein the device location agnostic device management client 126, 136 is an Open Mobile Alliance Device Management (OMA-DM) client.
